(19) United States
(12) Patent Application Publication
(10) Pub. No.: US 2024/0422696 A1
(43) Pub. Date: Dec. 19, 2024

(54) Method and Interface for Information Interaction in O-RAN

(71) Applicant: Mavenir Networks, Inc., Richardson, TX (US)

(72) Inventors: Yan WANG, Beijing (CN); Ming ZHU, Beijing (CN); Fan YANG, Beijing (CN); Jiaxing TIAN, Beijing (CN)

(73) Assignee: Mavenir Networks, Inc., Richardson, TX (US)

(21) Appl. No.: 18/815,120

(22) Filed: Aug. 26, 2024

Related U.S. Application Data
(63) Continuation of application No. PCT/CN2022/078545, filed on Mar. 1, 2022.

(51) Int. Cl. H04W 52/32; H04W 52/24; H04W 52/42

(52) U.S. Cl. CPC H04W 52/325; H04W 52/241; H04W 52/42

(57) ABSTRACT

There is provided a method of operating an Open Radio Access Network (O-RAN) 5G Functional Application Platform Interface (FAPI) between an O-RAN distributed unit (O-DU) PHY (Layer-1 entity, L1), i.e., O-DU L1, and an O-DU MAC (Layer-2 entity, L2), i.e., O-DU L2. The method includes (a) sending, from the O-DU L2 to the O-DU L1, a message informing the O-DU L1 to perform a User Equipment (UE) correlation calculation, and on which Sounding Reference Signal (SRS) resources the correlation calculation needs to be conducted, (b) sending, from the O-DU L1 to the O-DU L2, a message containing correlation information of UEs served in a cell, and (c) sending, from the O-DU L1 to the O-DU L2, a message containing information of the SRS power, noise and interference of each UE served in the cell.

### BACKGROUND OF THE DISCLOSURE

### 1. Field of the Disclosure

The present document relates to fifth generation (5G) telecommunications, and more specifically, an enhancement to the Small Cell Forum (SCF) 5G functional application platform interface (FAPI).

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

5G calls for new levels of flexibility in architecting, scaling and deploying telecom networks.

Cloud Radio Access Network (RAN) is a viable option for communications service providers to have increased flexibility, faster delivery of services, and greater scalability in networks. Cloud RAN entails the migration from custom-built network nodes to network functionality implemented in software running on a generic hardware compute platform.

Open RAN (O-RAN) is an industry term for open radio access network architecture with open interoperable interfaces and hardware-software disaggregation. O-RAN Alliance has specified hardware and software decoupling of all O-RAN elements, including RAN Intelligent Controller (RIC), Open RAN Centralized Unit (O-CU), Open RAN Distributed Unit (O-DU), and Open RAN Remote Unit (O-RU) based on lower layer split (LLS).

The 5G Functional Application Platform Interface (FAPI) is an initiative within the small cell industry released by the Small Cell Forum (SCF), which establishes interoperability and innovation among suppliers of platform hardware, platform software and application software. It does so by providing a common API around which suppliers can create a competitive ecosystem. In the O-RAN architecture, 5G FAPI connects the O-DU PHY, i.e., Layer-1 (L1), and Medium Access Control (MAC), i.e., Layer-2 (L2).

Massive MIMO (massive multiple-input multiple-output) is a type of wireless communications technology in which base stations are equipped with a very large number of antenna elements to improve spectral and energy efficiency. Using spatial multiplexing with MU-MIMO (Multi-User MIMO), 5G New Radio (NR) systems can simultaneously communicate with multiple user equipment (UEs) using the same time-frequency resources.

In multi-user MIMO, different streams produced using combination of different antennas are focused to different users or subscribers. Moreover, one stream can serve more than one users or subscribers.

To achieve the target of improved spectral efficiency and increased throughput of the cell, the 5G O-DU should select appropriate UEs as a user group to share the same transmission resource in order to make the interference between them as low as possible. As thus the 5G O-DU needs to obtain the antenna and beam information of each UE, based on which the correlations between different UEs could be obtained, thereafter those UEs with lowest correlation could be chosen as a user group sharing the identical radio resource for the Up Link/Down Link (UL/DL) transmission.

A problem is determining which input information is required by the 5G O-DU in order to infer the correlations between UEs served by the underlaying cell and candidate for MU-MIMO, and which entity in the O-DU is responsible to conduct the calculation of correlations based on the input information.

Another problem is how to conduct the power control of Physical Uplink Shared Channel (PUSCH) and Sounding Reference Signal (SRS) for a UE coordinatively and unitedly when utilizing MU-MIMO technique in the cell in order to reduce the intra-cell intra-group and inter-cell interference.

### SUMMARY OF THE DISCLOSURE

The present document discloses an enhancement of the 5G FAPI to improve the information interaction within the O-RAN supporting MU-MIMO and power control function.

There is provided a method of operating an Open Radio Access Network (O-RAN) 5G Functional Application Platform Interface (FAPI) between an O-RAN distributed unit (O-DU) PHY (Layer-1 entity, L1), i.e., O-DU L1, and an O-DU MAC (Layer-2 entity, L2), i.e., O-DU L2. The method includes (a) sending, from the O-DU L2 to the O-DU L1, a message informing the O-DU L1 to perform a User Equipment (UE) correlation calculation, and on which Sounding Reference Signal (SRS) resources the correlation calculation needs to be conducted, (b) sending, from the O-DU L1 to the O-DU L2, a message containing correlation information of UEs served in a cell, and (c) sending, from the O-DU L1 to the O-DU L2, a message containing information of the SRS power, noise and interference of each UE served in the cell.

### BRIEF DESCRIPTION OF THE DRAWINGS

FIG. 1 is a block diagram of a system that enhances the SCF FAPI between the O-DU L1 and an O-DU L2 for an O-RAN-based RAN.

FIG. 2 is a signal flow diagram for UE correlation calculation in an L1 entity.

FIG. 3 shows interaction signalling flow over a 5G FAPI.

A component or a feature that is common to more than one drawing is indicated with the same reference number in each of the drawings.

### DESCRIPTION OF THE DISCLOSURE

Per the present SCF FAPI specification, the O-DU Layer-1 (L1) obtains the SRS Report from the O-RU, which contains the complex channel Nu*Ng matrix H estimated between the UE's Nu antenna ports and gNBs Ng antenna ports, H [uI, gI] represents the flat fading approximation of the channel between the uI-th antenna at the UE and the gI-th antenna at the gNB.

The L1 entity of the O-DU transfers the matrix H of each served UE to the Layer-2 (L2) entity via the FAPI. Consequently, the L2 entity calculates the correlations between different UEs based on the received matrix H of each UE, and then selects the appropriate UEs based on the correlation outcome to form MU groups for scheduling both DL and UL MIMO. As a result, the UEs within one group could share the same time/frequency resource for data transmission.

It should be observed that the dimension of matrix H is the number of UE antenna multiplied by the number of gNB antenna per precoding resource block group (PRG) per UE, and each item of the matrix is the normalized I/Q representation, which size is 2 or 4 bytes (i.e. iqSize is 16 or 32bits). Also, this matrix H needs to be transferred between L1 and L2 at every period configured for SRS report. For example:

If:
Num of UE antenna ports=2, num of gNB antenna port=32
PRG num=272 (i.e. matrix H per RB), iqSize=2,

then the data volume of the matrix H is 2*32*272*2=34816 byte.

Assuming the period of SRS report is 20 ms, thereby the occupied bandwidth of one UE's matrix His 34816 byte/20 ms=1740 KB/s=13.3 Mbps

Based on the above example, we can observe the matrix H information of one UE will demand 13.3 Mbps bandwidth of the interface between L1 entity and L2 entity. If the num of served UEs by the cell reach hundreds, only the bandwidth required for the matrix H would be reaching ˜Gbps, and if taking into account of user plane (UP) data volume of every served UE, the bandwidth demand for FAPI would be significantly high, and maybe not acceptable from the CAPEX point of view.

Furthermore, as per the FAPI spec, the O-DU L1 obtains the SRS Report from the O-RU, which contains the signal-to-noise ratio (SNR) on wideband/resource block per UE and transfers this information to L2 entity via the FAPI, and then L2 entity conducts the UL power control calculation based on it.

However, the 5G standardization supports both the UL power control options based on SNR contained in SRS report, also the option based on the SRS power, noise and interference. The approach compliant to the present 5G FAPI specification cannot support the latter alternative, which would restrict the interoperability and integration between different vendors of L1 and L2 software, especially in case L1 and L2 located on different physical elements.

The techniques disclosed herein enhance the present SCF 5G FAPI specification, and include:
(a) introduction of a new message, i.e. Channel_Vector.indication, containing the correlation information between SRS resource configured corresponding to the UEs served in the cell;
(b) addition of flags in UL_TTI.request message, indicating whether or not to enable UE correlation calculation in L1 entity and on which SRS resources the correlation calculation needs to be conducted; and
(c) addition of received SRS power, noise and interference in the SRS Protocol Data Unit (PDU) contained in the SRS.indication message.

With the enhancement on the SCF FAPI, the following objectives and benefits can be achieved:
1) Supporting of the UEs correlation calculation within the L1 entity of O-DU, and the outcome is transferred via FAPI to L2 entity, enabling the L2 entity to determine which UEs are suitable for MU-MIMO while which UEs for single user MIMO (SU-MIMO), and then conduct the selection of appropriate UEs to form MU groups based on the correlation outcome from the L1 entity; consequently, the UEs within a MU group could be scheduled on the same radio resource for data transmission. By this means, the data volume of UE correlation information transferred over the FAPI is much smaller than that of the present matrix H, significantly reducing the bandwidth demand and the cost of O-DU.

2) Supporting the SRS power, noise and interference contained in the SRS PDU transferred from the O-DU L1 entity to L2 entity, enabling the L2 entity to perform the UL power control based on this type of information in addition of SNR, which allows the L2 internal power control algorithm to make coordination between SRS and PUSCH, thereby perform the unified power control on SRS and PUSCH.

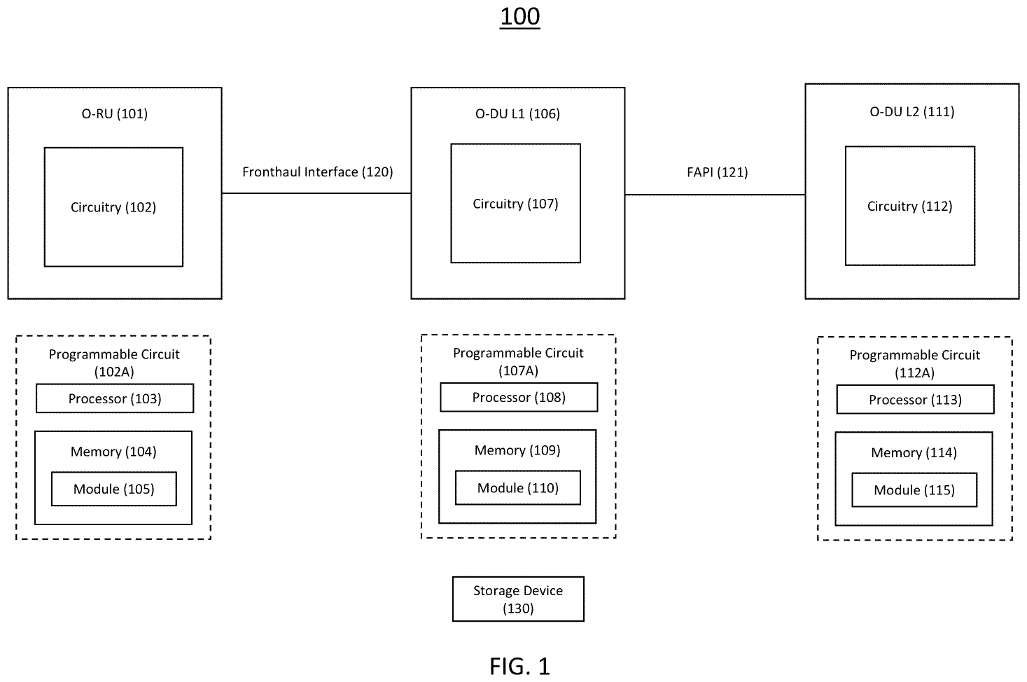

FIG. 1 is a block diagram of a system 100 that enhances an SCF FAPI between an O-DU L1 and an O-DU L2 for an O-RAN-based RAN. System 100 includes an O-RU 101, an O-DU L1 106, and an O-DU L2 111. The O-RU and O-DU L1 are communicatively coupled via a fronthaul interface 120, while the O-DU L1 and O-DU L2 are communicatively coupled via a 5G FAPI, referred to herein as FAPI 121. A variety of data is communicated via FAPI 121, including DL and UL U-plane data packets, DL and UL C-plane messages.

O-RU 101 includes electronic circuitry, namely circuitry 102, that performs operations on behalf of O-RU 101 to execute methods described herein. Circuity 102 may be implemented with any or all of (a) discrete electronic components, (b) firmware, and (c) a programmable circuit 102A. O-RU 101 represents mainly an O-RAN-compliant O-RU which executes the lower physical layer blocks such as Fast Fourier Transform/Inverse Fast Fourier Transform (FFT/IFFT), Control Plane (CP) removal/addition, beamforming, analog to digital converter, digital to analog convertor, and Radio Frequency (RF) functions.

Programmable circuit 102A, which is an optional implementation of circuitry 102, includes a processor 103 and a memory 104. Processor 103 is an electronic device configured of logic circuitry that responds to and executes instructions. Memory 104 is a tangible, non-transitory, computer-readable storage device encoded with a computer program. In this regard, memory 104 stores data and instructions, i.e., program code, that are readable and executable by processor 103 for controlling operations of processor 103. Memory 104 may be implemented in a random-access memory (RAM), a hard drive, a read only memory (ROM), or a combination thereof. One of the components of memory 104 is a program module, namely module 105. Module 105 contains instructions for controlling processor 103 to execute operations described herein on behalf of O-RU 101.

O-DU L1 106 includes electronic circuitry, namely circuitry 107, that performs operations on behalf of O-DU L1 106 to execute methods described herein. Circuity 107 may be implemented with any or all of (a) discrete electronic components, (b) firmware, and (c) a programmable circuit 107A. O-DU L1 106 represents the Layer-1 of an O-RAN compliant O-DU which executes functions such as higher physical layer (based on O-RAN split or similar lower layer splits). O-DU L1 106 can be implemented on proprietary hardware or COTS (commercial over the shelf servers) and it can be on the cloud.

Programmable circuit 107A, which is an optional implementation of circuitry 107, includes a processor 108 and a memory 109. Processor 108 is an electronic device configured of logic circuitry that responds to and executes instructions. Memory 109 is a tangible, non-transitory, computer-readable storage device encoded with a computer program. In this regard, memory 109 stores data and instructions, i.e., program code, that are readable and executable by processor 108 for controlling operations of processor 108. Memory 109 may be implemented in a random-access memory (RAM), a hard drive, a read only memory (ROM), or a combination thereof. One of the components of memory 109 is a program module, namely module 110. Module 110 contains instructions for controlling processor 108 to execute operations described herein on behalf of O-DU L1 106.

O-DU L2 111 includes electronic circuitry, namely circuitry 112, that performs operations on behalf of O-DU L2 111 to execute methods described herein. Circuity 112 may be implemented with any or all of (a) discrete electronic components, (b) firmware, and (c) a programmable circuit 112A. O-DU L2 111 represents the Layer-2 of an O-RAN compliant O-DU which executes functions such as Medium Access Control (MAC), scheduler, and Radio Link Control (RLC). O-DU L2 111 can be implemented on proprietary hardware or COTS and it can be on the cloud.

Programmable circuit 112A, which is an optional implementation of circuitry 112, includes a processor 113 and a memory 114. Processor 113 is an electronic device configured of logic circuitry that responds to and executes instructions. Memory 114 is a tangible, non-transitory, computer-readable storage device encoded with a computer program. In this regard, memory 114 stores data and instructions, i.e., program code, that are readable and executable by processor 113 for controlling operations of processor 113. Memory 114 may be implemented in a random-access memory (RAM), a hard drive, a read only memory (ROM), or a combination thereof. One of the components of memory 114 is a program module, namely module 115. Module 115 contains instructions for controlling processor 113 to execute operations described herein on behalf of O-DU L2 111.

The term “module” is used herein to denote a functional operation that may be embodied either as a stand-alone component or as an integrated configuration of a plurality of subordinate components. Thus, each of modules 105, 110 and 115 may be implemented as a single module or as a plurality of modules that operate in cooperation with one another.

While module 105, 110 and 115 are indicated as being already loaded into memories 104, 109 and 114, respectively, each of module 105, 110 and 115 may be configured on a storage device 130 for subsequent loading into their respective memories 104, 109 and 114. Storage device 130 is a tangible, non-transitory, computer-readable storage device that stores each of module 105, 110 and 115 thereon. Examples of storage device 130 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random-access memory, and (i) an electronic storage device coupled to O-RU 101, and/or O-DU L1 106 and/or O-DU L2 111 via a data communications network.

Fronthaul Interface 120 is the connection link between the O-DU and O-RU carrying CUS-plane packets as well as M-plane packets.

FAPI 121 is the connection link between the O-DU L1 entity (PHY) and L2 entity (MAC), in case the L1 entity and L2 entity reside in a single physical element, the FAPI is an internal logical interface within O-DU; while in case the L1 entity and L2 entity reside in different elements, the FAPI is a logical interface over the nFAPI (network FAPI) connecting the physical elements.

System 100 supports the option implementation, which enables the calculation of UE correlation conducted within the L1 entity of O-DU and the report of SRS power, noise and interference to L2 entity.

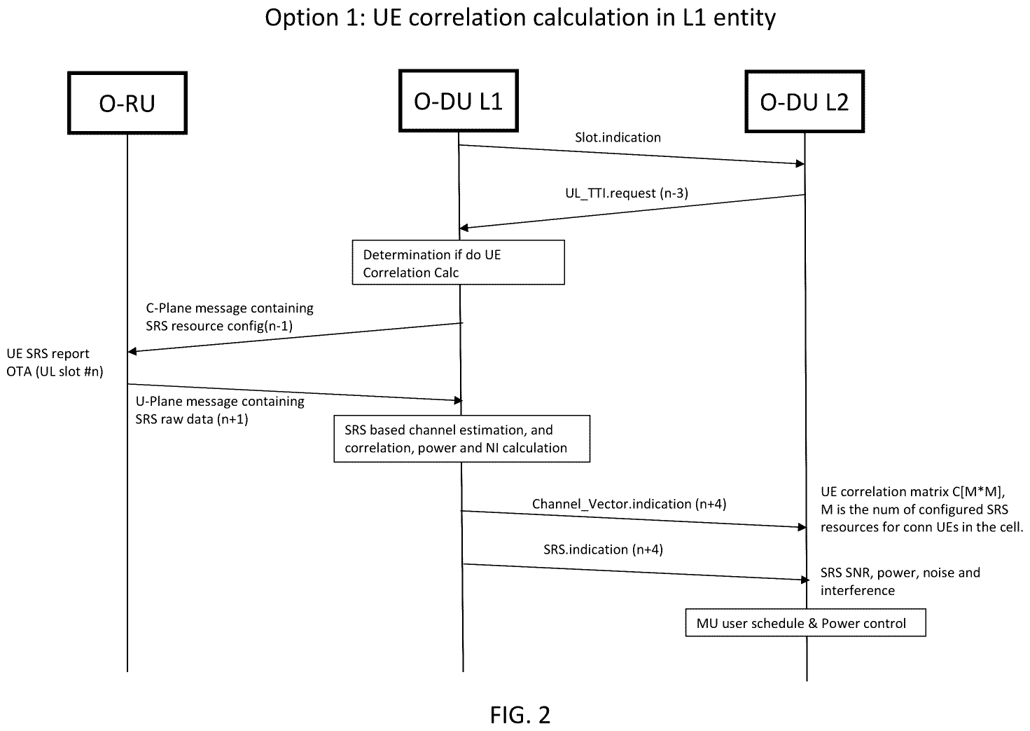

FIG. 2 is a signal flow diagram for UE correlation calculation in an L1 entity, and shows the interaction signalling flow over 5G FAPI.
1) L1 sends Slot.indication message to L2, indicating the current timing information including System Frame Number (SFN) and slot num, based on which L2 will do the SRS report schedule accordingly.
2) At slot #n−3, L2 sends UL_TTI.request message to L1, containing SRS resources configuration for the connected UEs, also the indication flag of UE correlation calculation and on which SRS resources the correlation calculation needs to be conducted in the current cell.
3) According to the indication from O-DU L2, O-DU L1 determines to do UE correlation calculation in the cell.
4)O-DU L1 delivers a C-Plane message containing the SRS resource configuration of the connected UEs to the O-RU via O-RAN fronthaul interface at slot #n−1.
5) At slot #n, the O-RU receives the SRS report from UEs over the air.
6) At slot #n+1, the O-RU delivers a U-Plane message containing SRS raw sample data of the UEs to the O-DU L1 via O-RAN fronthaul interface.
7) Upon reception of the SRS raw data, the L1 performs the channel estimation based on these data and calculates the correlation between SRS resources corresponding to connected UEs in the cell according to the indication from L2 in step 2 and gets the outcome, also L1 calculates the SRS power, noise and interference based on these data.
8) At slot #n+4, O-DU L1 delivers the Channel_Vector.indication message to O-DU L2, containing the outcome of correlation. Meanwhile, L1 also delivers the SRS.indication message to L2 containing SRS SNR, power, noise and interference, etc., except the matrix H.
9) Based on the correlation outcome of SRS resources (corresponding to UEs) received from O-DU L1, O-DU L2 can determine which UEs are suitable for MU-MIMO while which UEs for SU-MIMO, and then conducts selection of appropriate UEs to form MU groups and performs consequent radio resource schedule for each MU group having data ready to be transmitted. Meanwhile, L2 also performs the power control for SRS and PUSCH for the UE coordinately based on the SRS power, noise and interference received from L1.

The time variation of each message in the above description is only an example of implementation, and should not be regarded as a limitation.

The UE correlation outcome calculated by L1 entity is a symmetric matrix C (i, j) with dimension M*M, where M is the number of the SRS resources configuration for all connected UEs in the cell, and C (i, j) is the correlation value of SRS resource index i and j as below:

$$C ( i , j ) = Hi * {H}_{j}^{′} / \vert {H}_{i} \vert * \vert {H}_{j} \vert$$

Where, Hᵢ is the UL channel matrix based on SRS resource index i, Hⱼ is the UL channel matrix based on SRS resource index j.

Table-1, below, shows the format of a Channel_Vector.indication message.

TABLE-1
Channel_Vector.indication message body

| Field | Type | Description |
|---|---|---|
| SFN | uint16_t | SFN |
| | | Value: 0->1023 |
| Slot | uint16_t | Slot |
| | | Value: 0->159 |
| UE Correlation | uint16_t[M*M] | Array of (M*M) entries of |
| Matrix C | | correlation value between SRS |
| | | resources. |
| | | C[i,j] denotes the correlation value |
| | | between SRS resource index i and j. |
| | | M is the number of SRS resource |
| | | configured for all connected UEs in |
| | | the cell. |
| | | Value of C[i,j]: 0->32768 |

The enhancement of UL_TTI.request message is the addition of flags indicating PHY to calculate UE correlation or not, and which SRS indexes should be calculated, and the format is given in Table-2, below.

TABLE-2
Enhancement of UL_TTI.request message body

| Field | Type | Description |
|---|---|---|
| . . . | . . . | . . . |
| isCorrelationReport | uint8_t | Indicates PHY whether to calculate |
| | | correlation or not. |
| | | Value: 1 enable; 0 disable. |
| CorrelationCalc | uint8_ | Array of (M*M) entries of correlation |
| Matrix F | t[M*M] | flag indicating for which SRS resource |
| | | pairs correlation needs to be calculated. |
| | | F[i,j]: if set 1 means correlation |
| | | calculation between SRS resource index |
| | | i and j is needed, otherwise (set 0) not |
| | | needed. |
| | | M is the number of SRS resource |
| | | configured for all connected UEs in the |
| | | cell. |
| | | If this field is absent, the PHY needs to |
| | | calculate correlations for all SRS |
| | | resource combination configured in the |
| | | cell. |
| | | This field can be present only if |
| | | isCorrelationReport set 1. |

The enhancement of an SRS.indication message is the addition of SRS power, noise and interference, which format is given in the Table-3 below.

TABLE-3
Enhancement of SRS.indication message body

| Field | Type | Description |
|---|---|---|
| . . . | . . . | . . . |
| PsSrs | int16_t | The received SRS power, and the |
| | | unit is dBm. |
| | | Value: [−1500, 500], the real SRS |
| | | power is the value*0.1 dBm, e.g., |
| | | −1500 denotes −150 dBm, |
| | | −1490 denotes −149 dBm, |
| | | 500 denotes 50 dBm |
| | | and so on. |
| NISrs | int16_t | The received SRS noise and |
| | | interference, and the unit is dBm. |
| | | Value: [−1500, 500], the real SRS |
| | | noise and interference is the |
| | | value*0.1 dBm, e.g., |
| | | −1500 denotes −150 dBm, |
| | | −1490 denotes −149 dBm, |
| | | 500 denotes 50 dBm |
| | | and so on. |

The technique disclosed herein can also support the option implementation, which complies to the current 5G FAPI spec, i.e., the UEs correlation calculation conducted within the L2 entity of O-DU.

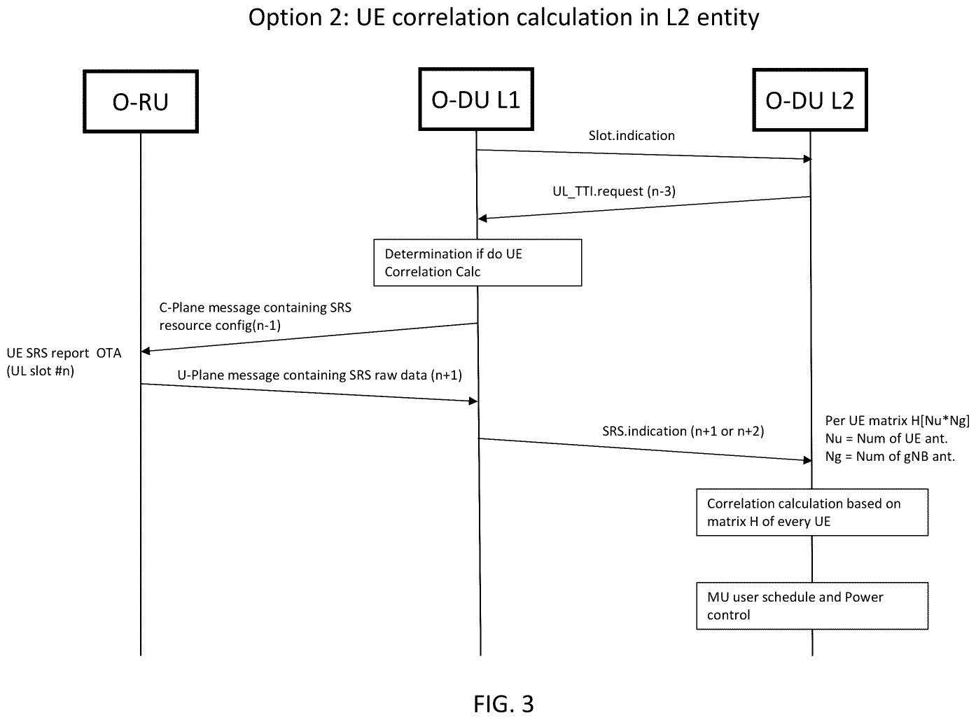

FIG. 3 shows interaction signalling flow over a 5G FAPI.
1)O-DU L1 sends Slot.indication message to O-DU L2, indicating the current timing information including SFN and slot num, based on which O-DU L2 will do the SRS report schedule accordingly.
2) At slot #n−3, O-DU L2 sends UL_TTI.request message to O-DU L1, containing SRS resource configuration of connected UEs in the cell, also indicating L1 NOT to conduct UE correlation calculation in the current cell.
3) According to the indication from O-DU L2, O-DU L1 determines not to do UE correlation calculation in the cell.
4)O-DU L1 delivers a C-Plane message containing the SRS resource configuration of the connected UEs to the O-RU via O-RAN fronthaul interface at slot #n−1.
5) At slot #n, the O-RU receives the SRS report of the UEs over the air.
6) At slot #n+1, O-RU delivers a U-Plane message containing SRS raw sample data of the UEs to the O-DU L1 via O-RAN fronthaul interface.
7) Upon reception of the SRS raw data from O-RU, at slot n+1 or n+2 the O-DU L1 delivers the SRS.indication message to O-DU L2 containing the matrix H per UE, and also the SRS wideband SNR, etc.
8)O-DU L2 performs calculation of the correlation based on the matrix H of each connected UE in the cell, and then based on the outcome selects the appropriate UEs to form different MU groups for consequent radio resource schedule. Meanwhile, L2 also performs the power control for SRS for each connected UE based on the received wideband SNR.

The time variation of each message in the above description is only an example of implementation, and should not be regarded as a limitation.

### Acronyms

3GPP: Third generation partnership project
BS: Base Station
CAPEX: Capital Expenditure
COTS: Commercial off-the-shelf
C-plane: Control plane
C-RAN: Cloud radio access network
CU: Central unit
DL: Downlink
DU: Distribution unit
gNB: gNodeB (applies to NR)
MAC: Medium Access Control
MIMO: Multiple input, multiple output
O-DU: O-RAN Distributed Unit
O-RU: O-RAN Radio Unit
O-RAN: Open RAN (Basic O-RAN specifications are prepared by the O-RAN
alliance)
OPEX: Operating Expense
PDCP: Packet Data Convergence Protocol
RLC: Radio Link Control
RRC: Radio Resource Control
RRH: Remote Radio Head
RU: Radio Unit
SDAP: Service Data Adaptation Protocol
SFN: System Frame Number
SRS: Sounding reference signal
TRP: Transmission Reception Point
U-plane: User plane
UE: User equipment
UL: Uplink

### Definitions

Channel: The contiguous frequency range between lower and upper frequency limits.

C-plane: Control Plane: Refers specifically to real-time control between O-DU and O-RU, and should not be confused with the UE's control plane.

DL: DownLink: Data flow towards the radiating antenna (generally on the LLS interface).

LLS: Lower Layer Split: Logical interface between O-DU and O-RU when using a lower layer (intra-PHY based) functional split.

O-CU: O-RAN Control Unit: A logical node hosting PDCP, RRC, SDAP and other control functions.

O-DU: O-RAN Distributed Unit: A logical node hosting RLC/MAC/High-PHY layers based on a lower layer functional split.

O-RU: O-RAN Radio Unit: A logical node hosting Low-PHY layer and RF processing based on a lower layer functional split. This is similar to 3GPP's “TRP” or

“RRH” but more specific in including the Low-PHY layer (FFT/IFFT, PRACH extraction).

OTA: Over the Air.

U-Plane: User Plane: refers to IQ sample data transferred between O-DU and O-RU.

UL: UpLink: data flow away from the radiating antenna (generally on the LLS interface).

The techniques described herein are exemplary, and should not be construed as implying any particular limitation on the present disclosure. It should be understood that various alternatives, combinations and modifications could be devised by those skilled in the art. For example, operations associated with the processes described herein can be performed in any order, unless otherwise specified or dictated by the operations themselves. The present disclosure is intended to embrace all such alternatives, modifications and variances that fall within the scope of the appended claims.

The terms “comprises” or “comprising” are to be interpreted as specifying the presence of the stated features, integers, operations or components, but not precluding the presence of one or more other features, integers, operations or components or groups thereof. The terms “a” and “an” are indefinite articles, and as such, do not preclude embodiments having pluralities of articles.

What is claimed is:

1. A method of operating an Open Radio Access Network (O-RAN) 5G Functional Application Platform Interface (FAPI) between an O-RAN distributed unit (O-DU) PHY Layer-1 entity, L1 (O-DU L1) and an O-DU MAC Layer-2 entity, L2 (O-DU L2), comprising:
sending, from said O-DU L2 to said O-DU L1, a message informing said O-DU L1 to perform a User Equipment (UE) correlation calculation, and on which Sounding Reference Signal (SRS) resources said correlation calculation needs to be conducted;
sending, from said O-DU L1 to said O-DU L2, a message containing correlation information of UEs served in a cell; and
sending, from said O-DU L1 to said O-DU L2, a message containing information of said SRS power, noise and interference of each UE served in said cell.

2. The method of claim 1, further comprising:
sending, from said O-DU L1 to said O-DU L2, via a 5G FAPI, a message that includes an outcome of said correlation calculation.

3. The method of claim 2, further comprising:
determining, by said O-DU L2, which UEs are suitable for multiple user multiple input multiple output (MU-MIMO) and which UEs are for single user multiple input multiple output (SU-MIMO); and
selecting, by said O-DU L2, UEs to form MU groups.

4. The method of claim 1, further comprising:
calculating, by said O-DU L1, SRS power, noise and interference based on SRS raw data of each UE received from said O-RU, thus yielding an SRS power, noise and interference calculation; and
sending, from said O-DU L1 to said O-DU L2, via a 5G FAPI, an SRS.indication message that includes said SRS power, noise and interference calculation.

5. The method of claim 4, further comprising:
performing, by said O-DU L2, unified power control on said SRS and a Physical Uplink Shared Channel (PUSCH), based on said SRS power, noise and interference calculation and a signal-to-noise ratio (SNR) contained in said SRS.indication message.

6. A method of operating an Open Radio Access Network (O-RAN) 5G Functional Application Platform Interface (FAPI) between an O-DU L1 and an O-DU L2, wherein said O-DU L1 performs operations comprising:
performing a channel estimation based on Sounding Reference Signal (SRS) raw data of each served User Equipment (UE) received from an O-RAN Radio Unit (O-RU); and
calculating a correlation of said SRS resources configured corresponding to UEs in a cell based on a result of said channel estimation.

7. The method of claim 6, wherein said O-DU L1 sends a message to said O-DU L2 via a 5G FAPI, that includes an outcome of said correlation calculation.

8. The method of claim 7, wherein said O-DU L2 determines which UEs are suitable for multiple user multiple input multiple output (MU-MIMO), and which UEs are for single user multiple input multiple output (SU-MIMO), and then selects UEs to form MU groups.

9. The method of claim 8, wherein said O-DU L1 calculates SRS power, noise and interference based on SRS raw data of each UE received from said O-RU, and includes these results in an SRS.indication message delivered to said O-DU L2 via a 5G FAPI.
